(19) United States
(12) Patent Application Publication
(10) Pub. No.: US 2012/0061179 A1
(43) Pub. Date: Mar. 15, 2012

(54) TELESCOPING LADDER JACK

(76) Inventor: Jody James English, Battle Creek, MI (US)

(21) Appl. No.: 13/285,130

(22) Filed: Oct. 31, 2011

Related U.S. Application Data
(63) Continuation-in-part of application No. 11/321,674, filed on Dec. 29, 2005, now Pat. No. 8,047,330.
(60) Provisional application No. 60/640,446, filed on Dec. 30, 2004.

(51) Int. Cl. E06C 7/00; E06C 1/04

(52) U.S. Cl. 182/121; 182/129

(57) ABSTRACT

A telescoping ladder jack includes a housing and telescoping beam matingly inserted into and extracted from the housing such that a first desired effective length of the beam is extracted from the housing. A first locking mechanism fixes the beam at the first length. A bracket defines opposing first and second ends (the first end pivotally attached to an end of the housing) and is mounted to a ladder to mount the jack to the ladder. A telescoping tube is mounted to the housing. An adjustable brace is matingly inserted into and extracted from the tube such that a second desired effective length of the brace is extracted from the tube. An end of the brace is pivotally mounted to the second end of the bracket. A second locking mechanism fixes the brace at the second length and housing to a desired angle of incline with respect to the bracket.

### REFERENCE TO RELATED APPLICATIONS

This is a “continuation in part” application that claims benefit of the filing date of and priority to U.S. Regular Utility patent application 11/321,674 filed on Dec. 29, 2005 and entitled “Telescoping Ladder Jack” (now U.S. Pat. No. 8,047,330 issued on Nov. 1, 2011), which, in turn, claims benefit of the filing date of and priority to U.S. Provisional Patent Application 60/640,446 filed on Dec. 30, 2004 and entitled “Telescoping Ladder Jack.”

### BACKGROUND OF INVENTION

1. Field of Invention

The invention relates to, in general, a telescoping ladder jack and, in particular, such a jack that can be extended and retracted to a desired effective length and adjusted to a desired angle of incline.

2. Description of Related Art

A ladder jack is used by roofers, siders, painters, and others in a trade that perform work upon a surface—such as a roof or face of a structure—and a device for extending a plank/platform used in a scaffolding system away from the structure. More specifically, when two or more ladders are employed against the face of the structure (as in the scaffolding system), the ladder jack is attached to each of the ladders at respective equal heights thereof through use of a “hook” mechanism. When so attached, the ladder jack works to offer extension of the scaffold plank/platform away from the structure via a rigid member that facilitates support of the scaffold plank/platform.

The prior art discloses several devices that may be used as a ladder jack for support of a scaffold plank/platform. As an example, U.S. Pat. No. 5,020,757 discloses a ladder jack that is attached on an outside of the ladders via a hook and adjustable for varying degree of incline of the ladders and features a threaded bolt, wing nut, and bracket that serves as a stop for a work platform.

Furthermore, U.S. Pat. No. 6,045,102 discloses a multiple-use tool that combines a roof hook, roof bracket, and ladder jack. The tool, when it is employed as a ladder jack, is used on an outside of the ladders, locks into horizontal position via a locking mechanism that allows for adjustment of degree in incline of the ladders, and features a device to stop the work platform from sliding off an end of the tool. The tool employs a set of hooks for attachment of the tool to respective rungs of the ladders.

The work platform of each of these ladder jacks secures the scaffold plank/platform at an elevation thereof. However, the ladder jack is used on the outside of the ladder, thus limiting range of the, say, roofer, sider, or painter and not providing separation between the structure and ladder to facilitate work at higher elevation where pitch of the ladder narrows considerably. The ladder jack also cannot be set at varying lengths from the structure and securely lock a scaffold plank/platform of varying widths.

In addition, U.S. Pat. No. 4,542,874 discloses a bracket for support of a scaffold plank/platform that may be inverted for its use on an inside of the ladder. The bracket uses a ladder-rung hook and an adjustable arm for the bracket to accommodate varying degrees of incline of the ladder.

Thus, there remains a need in the related art for a ladder jack that is used on the inside of the ladder. There remains a need in the related art for such a ladder jack that also does not limit range of the, say, roofer, sider, or painter. There remains a need in the related art for such a ladder jack that also provides separation between the structure and ladder to facilitate work at higher elevation where pitch of the ladder narrows considerably. There remains a need in the related art for such a ladder jack that also can be set at varying lengths from the surface. There remains a need in the related art for such a ladder jack that can also securely lock a scaffold plank/platform of varying widths. There remains a need in the related art for such a ladder jack also the work platform of which is closer to the surface upon which work is being performed. There remains a need in the related art for such a ladder jack that can also accommodate variations in angle of incline of the ladder.

### SUMMARY OF INVENTION

The invention overcomes the problems in the related art in a telescoping ladder jack that includes a ladder-jack housing and telescoping beam adapted to be matingly inserted into and extracted from the ladder-jack housing such that a first desired effective length of the telescoping beam is extracted from the ladder-jack housing. A first locking mechanism fixes the telescoping beam at the first desired effective length. A ladder-rung bracket defines opposing first and second ends of the ladder-rung bracket (the first end being pivotally attached to an end of the ladder-jack housing disposed distal the telescoping beam) and is mounted to a ladder to mount the telescoping ladder jack to the ladder. A telescoping tube is mounted to the ladder-jack housing. An adjustable brace is adapted to be matingly inserted into and extracted from the telescoping tube such that a second desired effective length of the adjustable brace is extracted from the telescoping tube. An end of the adjustable brace disposed distal the telescoping tube is pivotally mounted to the second end of the ladder-rung bracket. A second locking mechanism is adapted to fix the adjustable brace at the second desired effective length and the ladder-jack housing to a desired angle of incline with respect to the ladder-rung bracket.

An advantage of the telescoping ladder jack of the invention is that it is used on the inside of the ladder.

Another advantage of the telescoping ladder jack of the invention is that it does not limit range of the, say, roofer, sider, or painter.

Another advantage of the telescoping ladder jack of the invention is that it provides separation between the structure and ladder to facilitate work at higher elevation where pitch of the ladder narrows considerably.

Another advantage of the telescoping ladder jack of the invention is that it can be set at varying lengths from the surface.

Another advantage of the telescoping ladder jack of the invention is that it can securely lock a scaffold plank/platform of varying widths.

Another advantage of the telescoping ladder jack of the invention is that the work platform thereof is closer to the surface upon which work is being performed.

Another advantage of the telescoping ladder jack of the invention is that it can accommodate variations in angle of incline of the ladder.

More specifically, another advantage of the telescoping ladder jack of the invention is that it employs a plurality of ladder-rung hooks.

Another advantage of the telescoping ladder jack of the invention is that it can adjust the ladder-rung hooks to varying degrees of incline.

Another advantage of the telescoping ladder jack of the invention is that the ladder-rung hooks can be used to position the telescoping ladder jack on the inside of a ladder.

Another advantage of the telescoping ladder jack of the invention is that it uses a telescoping beam that can be set at varying widths and locked in place.

Another advantage of the telescoping ladder jack of the invention is that it includes a securing mechanism that adjusts width of the scaffold plank/platform and can be set at varying lengths and remain set when the telescoping beam is used.

Another advantage of the telescoping ladder jack of the invention is that the ladder-rung hooks can be removably attached and allow the telescoping ladder jack to be used on an outside of a new-construction wall as a support for a scaffold plank/platform when the ladder-rung hooks are removed and the top ladder-rung hook is replaced with a wider top-wall-plate hook.

Another advantage of the telescoping ladder jack of the invention is that it includes two “telescoping” parts each of which is adapted to slide and be locked in a desired position such that the ladder-jack housing of the telescoping ladder jack can be raised and lowered to and locked in a desired angle.

Other objects, features, and advantages of the telescoping ladder jack of the invention will be readily appreciated as the same becomes better understood while reading the subsequent detailed description of embodiments of the telescoping ladder jack taken in conjunction with the accompanying respective drawings of such embodiments.

### BRIEF DESCRIPTION OF EACH FIGURE OF DRAWING

FIG. 1 is a perspective view of an embodiment of a telescoping ladder jack of the invention showing the telescoping beam thereof in a retracted position.

FIG. 2a is an elevated view of a side of the embodiment of the telescoping ladder jack of the invention illustrated in FIG. 1 showing the telescoping beam in an extended position.

FIG. 2b is an elevated view of a side (opposite the side of FIG. 2a) of the embodiment of the telescoping ladder jack of the invention illustrated in FIG. 1 showing the telescoping beam in an extended position.

FIG. 3 is an elevated cut-away top view of the telescoping-beam locking mechanism of the embodiment of the telescoping ladder jack of the invention illustrated in FIG. 1.

FIG. 4 is an elevated top view of the embodiment of the telescoping ladder jack of the invention illustrated in FIG. 1 showing the telescoping beam in the extended position.

FIG. 5 is an environmental view of the embodiment of the telescoping ladder jack of the invention illustrated in FIG. 1 showing the telescoping ladder jack mounted on an inside of a ladder.

FIG. 6 is an environmental view of another embodiment of the telescoping ladder jack according to the invention showing the telescoping ladder jack mounted on a ladder.

FIG. 7 is an enlarged isolated view of a portion of each of the telescoping tube and adjustable brace of the embodiment of the telescoping ladder jack illustrated in FIG. 6 showing the second desired effective length of the adjustable brace being extracted from the telescoping tube.

FIG. 8 is an enlarged isolated view of a portion of the telescoping beam of the embodiment of the telescoping ladder jack illustrated in FIG. 6 showing action of the first locking mechanism relative the telescoping beam such that the first desired effective length of the telescoping beam can be extracted from the ladder-jack housing.

### DETAILED DESCRIPTION OF EMBODIMENTS OF INVENTION

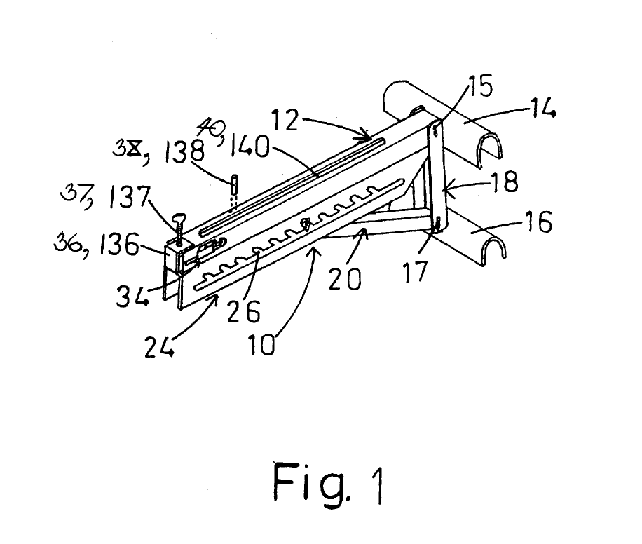

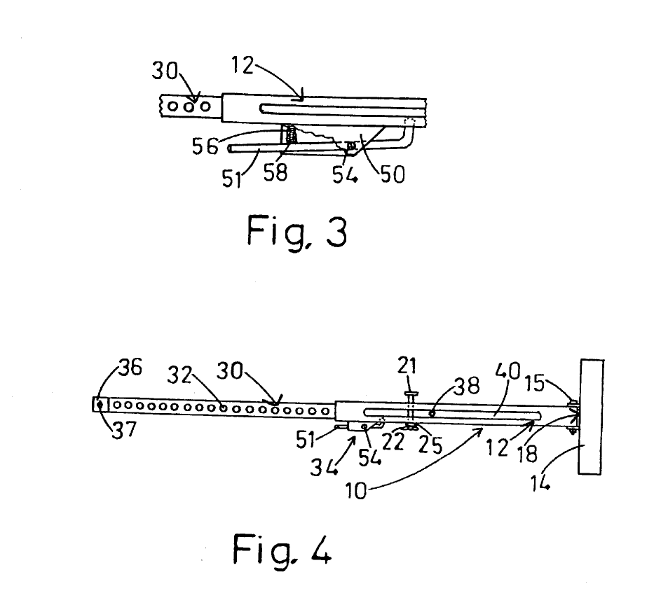

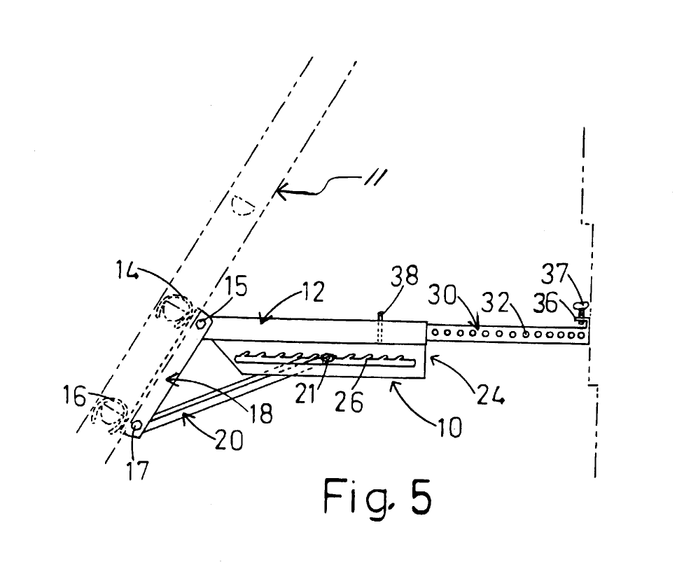

Referring to the figures, where like numerals are used to designate like structure, a telescoping ladder jack of the present invention is generally indicated at 10, 110. Although the telescoping ladder jack 10, 110 is described above in connection with use with a ladder and roof or face of a structure, those having ordinary skill in the related art should appreciate that the telescoping ladder jack 10, 110 can be used with the ladder and any suitable surface upon which work is being performed. Referring now specifically to FIGS. 1 through 5, an embodiment of the telescoping ladder jack 10 is shown per se in FIGS. 1, 2a, 2b, 3, and 4, in part in FIG. 3, and in its operative mode in FIG. 5.

As illustrated in FIG. 1, the telescoping ladder jack 10 includes a ladder-jack housing, generally indicated at 12, that serves as a main support for a scaffold plank/platform (not shown). A top ladder-rung hook 14 and bottom ladder-rung hook 16 are pivotally mounted to the ladder-jack housing 12 by a ladder-rung-hook bracket, generally indicated at 18. The ladder-jack housing 12 defines a substantially square transverse cross-section of the ladder-jack housing 12 and is a substantially hollow length of metal. The ladder-rung-hook bracket 18 defines a substantially U-shaped transverse cross-section of the ladder-rung-hook bracket 18. The top and bottom ladder-rung hooks 14, 16 are fixedly mounted to an outside surface of the ladder-rung-hook bracket 18. Two opposing inner sides of the ladder-rung-hook bracket 18 receive the ladder-jack housing 12 at substantially a top of the ladder-rung-hook bracket 18 and are pivotally mounted thereto by a nut-and-bolt assemblage 15.

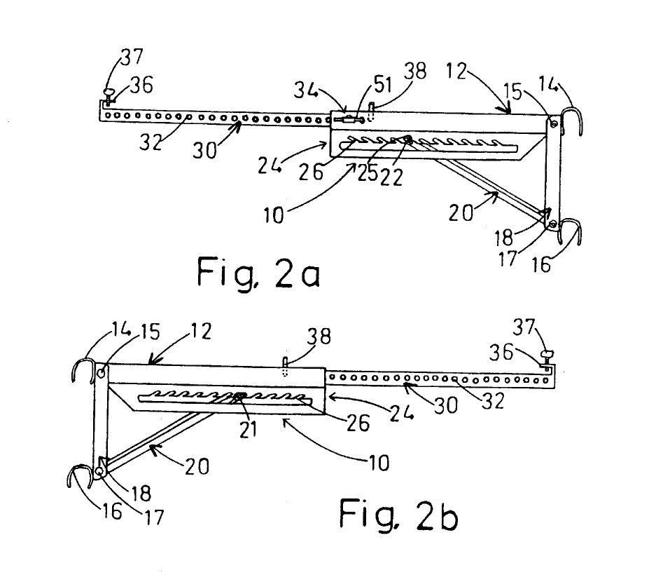

The telescoping ladder jack 10 includes also an adjustable brace, generally indicated at 20, that defines a substantially square transverse cross-section of the adjustable brace 20 and is a length of metal. A first end of the adjustable brace 20 is pivotally mounted at substantially a bottom of the ladder-rung-hook bracket 18 by a nut-and-bolt assemblage 17. A threaded through-bolt 21 (shown in FIGS. 2b, 4, and 5) passes substantially horizontally through a side of a second end of the adjustable brace 20 and engages a wing nut 22 and locking washer 25 on an opposing side of the adjustable brace 20. The second end of the adjustable brace 20 is received by an incline-adjustment locking mechanism, generally indicated at 24, that defines an inverted substantially U-shaped transverse cross-section and is fixedly attached to a bottom of the ladder-jack housing 12. On two opposing sides of the incline-adjustment locking mechanism 24 are defined a plurality of upwardly extending adjustment slots 26 adapted to engage the threaded through-bolt 21. To adjust the telescoping ladder jack 10 to a desired angle of incline, the through-bolt 21 may be inserted into a desired position within one of the adjustment slots 26 and secured within the adjustment slot 26 by tightening the wing nut 22 such that the wing nut 22 engages the locking washer 25 and is disposed against a corresponding side of the incline-adjustment locking mechanism 24.

As illustrated in FIGS. 2a and 2b, a telescoping beam, generally indicated at 30, may be manually extended from or retracted into the ladder-jack housing 12. The telescoping beam 30 defines a substantially square transverse cross-section of the telescoping beam 30, is a length of metal, and defines a plurality of longitudinally spaced holes 32 on each of four sides of the telescoping beam 30. A telescoping-beam locking mechanism, generally indicated at 34, locks the telescoping beam 30 in place. In particular, a spring-latch assembly 34 includes a latch rod 51, is fixedly attached at a side of the ladder-jack housing 12, and allows the latch rod 51 to be inserted into one of the longitudinally spaced holes 32, thereby locking the telescoping beam 30 in place.

As illustrated in FIG. 3, the latch rod 51 defines a substantially circular transverse cross-section of the latch rod 51 and is a length of metal bent at a substantially right angle at one end of the latch rod 51. The latch rod 51 is allowed to pass through and be pivotally mounted to a spring-latch-assembly housing 50 by a pivot screw 54 that passes through a top side of the spring-latch-assembly housing 50, the latch rod 51, and a bottom of the spring-latch-assembly housing 50. A coil-tension spring 56 is fixedly and substantially horizontally mounted to an inside wall of the spring-latch-assembly housing 50 and secured to the latch rod 51 by an arm 58 extended off the latch rod 51 and inserted through a substantial center of the coil-tension spring 56. The coil-tension spring 56 engages and applies pressure to the latch rod 51, thereby forcing the latch rod 51 to pivot and allowing the latch rod 51 to be secured in place when the latch rod 51 is inserted into one of the longitudinally spaced holes 32 in the telescoping beam 30.

As illustrated in FIG. 4, the telescoping ladder jack 10 is adapted to support a scaffold plank/platform (not shown). To this end, the telescoping ladder jack 10 includes further a securing mechanism to secure the scaffold plank/platform to the telescoping beam 30 and ladder-jack housing 12. The securing mechanism includes a fixed lock 36 mounted to an end of the telescoping beam 30 located distal the ladder-jack housing 12 and an adjustable locking pin 38 that fits into the telescoping beam 30 by passing through a slot 40 defined in a top of the ladder-jack housing 12. The scaffold plank/platform is secured between the lock 36 and adjustable locking pin 38 to the telescoping beam 30 and ladder-jack housing 12. The slot 40 extends a substantial length of the ladder-jack housing 12, and a screw 37 is threaded through the lock 36 to the scaffold plank/platform.

In particular, the lock 36 is fixedly attached to the end of the telescoping beam 30 (through which the screw 37 is threaded). The locking pin 38 defines a substantially circular transverse cross-section and corresponding diameter of the locking pin 38 such that the locking pin 38 can be removably inserted into one of the longitudinally spaced holes 32 in the telescoping beam 30. The locking pin 38 also is a length of steel such that the locking pin 38 is longer than a depth of the ladder-jack housing 12. The locking pin 38 also may be removably placed into one of the longitudinally spaced holes 32 through the slot 40 in a top side of the ladder-jack housing 12. The slot 40 exposes a desired number of the longitudinally spaced holes 32 in any length of the telescoping beam 30 remaining retracted inside the ladder-jack housing 12. An operator of the telescoping ladder jack 10 (such as a roofer, sider, or painter) may set the telescoping beam 30 at, say, the first desired effective length and secure the scaffold plank/platform of varying widths to the telescoping beam 30 and ladder-jack housing 12 without his/her having to disassemble the telescoping ladder jack 10 for him/her to set the locking pin 38.

In operation of the telescoping ladder jack 10 and as illustrated in FIG. 5, the top and bottom ladder-rung hooks 14, 16 engage respective rungs (not shown) of a ladder, generally indicated at 11, thus securing the telescoping ladder jack 10 in place. The telescoping ladder jack 10 may then be adjusted by use of the adjustable brace 20 and incline-adjustment locking mechanism 24. The telescoping beam 30 may then be set to the desired effective length, and the scaffold plank/platform may be secured to the exposed telescoping beam 30 and ladder-jack housing 12 by employment of the lock 36 and locking pin 38.

It should be appreciated by those having ordinary skill in the related art that each of the ladder-jack housing 12, top and bottom ladder-rung hooks 14, 16, nut-and-bolt assemblage 17, ladder-rung-hook bracket 18, adjustable brace 20, threaded through-bolt 21, wing nut 22, incline-adjustment locking mechanism 24, locking washer 25, telescoping beam 30, spring-latch assembly 34 (the latch rod 51, in particular), lock 36, screw 37, locking pin 38, spring-latch-assembly housing 50, pivot screw 54, coil-tension spring 56, and arm 58 can have any suitable shape, size, and structure and structural relationship with each of the other structural elements of the telescoping ladder jack 10 and be made of any suitable material (such as one that meets safety-compliance standards). It should be so appreciated also that each of the adjustment slots 26, longitudinally spaced holes 32, and slot 40 can have any suitable shape and size and structural relationship with each of the other structural elements of the telescoping ladder jack 10. It should be so appreciated also that the telescoping ladder jack 10 can define any suitable number of the adjustment slots 26, longitudinally spaced holes 32, and slot 40 and include any suitable number of ladder-rung hooks 14, 16 (which can engage any suitable respective rungs of the ladder 11). It should be so appreciated also that each of the ladder-rung hooks 14, 16, ladder-rung-hook bracket 18, adjustable brace 20, through-bolt 21, incline-adjustment locking mechanism 24, telescoping beam 30, spring-latch assembly 34, lock 36, locking pin 38, latch rod 51, and coil-tension spring 56 can be mounted or attached to, receive or be received by, be inserted into, be secured to or within, be extended from and retracted into, and/or fit into the corresponding structural elements of the telescoping ladder jack 10 and/or pivot in any suitable manner and location. It should be so appreciated also that the ladder 11 can be any suitable type of ladder. It should be so appreciated also that the telescoping beam 30 can be set to any suitable desired effective length and locked by any suitable method, including through-bolt and push-button locking systems.

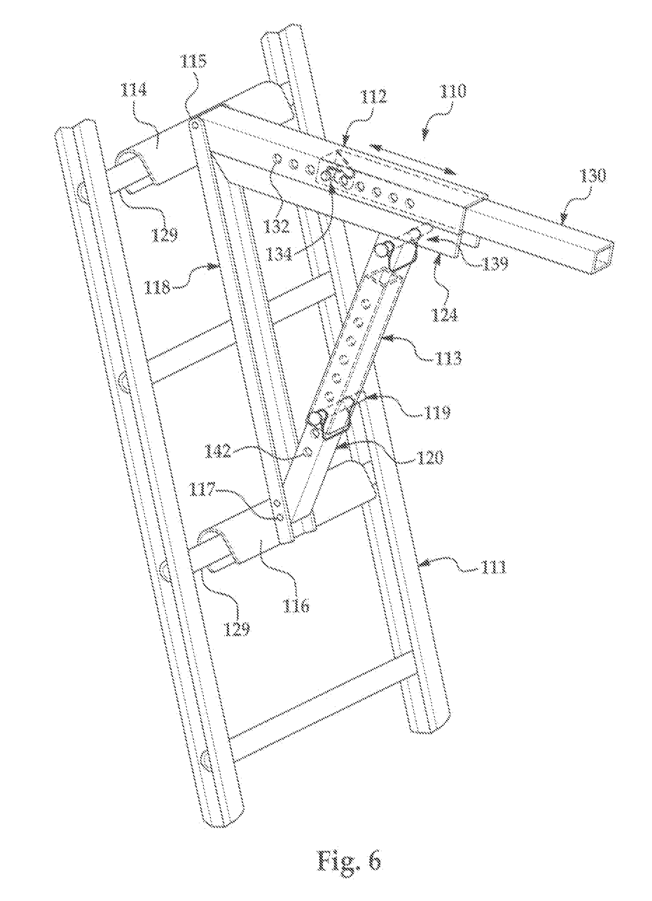

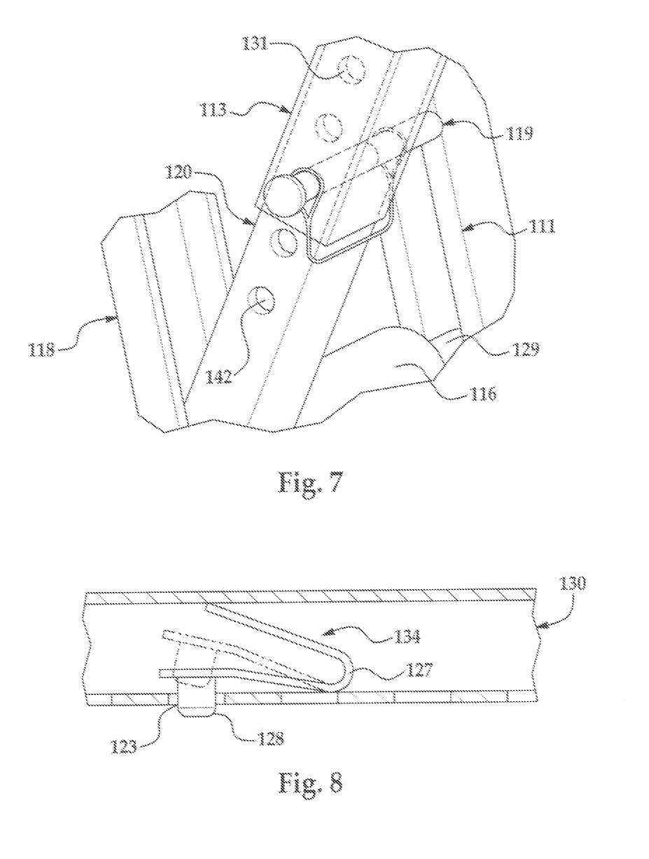

Referring now specifically to FIGS. 6 through 8, another embodiment of the telescoping ladder jack 110 is shown in its operative mode in FIG. 6 and in part in FIGS. 7 and 8. Parts of the telescoping ladder jack 110 corresponding to those of the telescoping ladder jack 10 have like reference numerals with respect to the telescoping ladder jack 10, but increased by one hundred (100). However, since structure relating to extension from or retraction into the ladder-jack housing 112 of the telescoping beam 130 and adjustment of the telescoping ladder jack 110 to a desired angle of incline vis-à-vis the structure relating to extension from or retraction into the ladder-jack housing 12 of the telescoping beam 30 and adjustment of the telescoping ladder jack 10 to a desired angle of incline are the only differences between the telescoping ladder jack 110 and the telescoping ladder jack 10, respectively, only these difference are described immediately below.

As illustrated in FIG. 6, the telescoping ladder jack 110 includes, in general, a ladder-jack housing, generally indicated at 112, and telescoping beam, generally indicated at 130, adapted to be matingly inserted into and extracted from the ladder-jack housing 112 such that a first desired effective length of the telescoping beam 130 is extracted from the ladder-jack housing 112. A first locking mechanism, generally indicated at 134, fixes the telescoping beam 130 at the first desired effective length. A ladder-rung bracket, generally indicated at 118, defines opposing first and second ends 115, 117 of the ladder-rung bracket 118 (the first end 115 being pivotally attached to an end of the ladder-jack housing 112 disposed distal the telescoping beam 130) and is mounted to a ladder, generally indicated at 111, to mount the telescoping ladder jack 110 to the ladder 111. A telescoping tube, generally indicated at 113, is mounted to the ladder-jack housing 112. An adjustable brace, generally indicated at 120, is adapted to be matingly inserted into and extracted from the telescoping tube 113 such that a second desired effective length of the adjustable brace 120 is extracted from the telescoping tube 113. An end of the adjustable brace 120 disposed distal the telescoping tube 113 is pivotally mounted to the second end 117 of the ladder-rung bracket 118. A second locking mechanism, generally indicated at 119, is adapted to fix the adjustable brace 120 at the second desired effective length and the ladder-jack housing 112 to a desired angle of incline with respect to the ladder-rung bracket 118.

More specifically, each of the ladder-jack housing 112 and telescoping beam 130 is substantially tubular and defines a substantially square transverse cross-section and hollow interior of the ladder-jack housing 112 and telescoping beam 130. A length of the ladder-jack housing 112 can be greater than, substantially equal to, or less than that of the telescoping beam 130, and an inner diameter defined by the ladder-jack housing 112 is only slightly greater than an outer diameter defined by the telescoping beam 130. The ladder-jack housing 112 defines also a plurality of longitudinally spaced holes 132 of the ladder-jack housing 112. In particular, the longitudinally spaced holes 132 are defined on at least a substantial length of one side of the ladder-jack housing 112 and spaced substantially equidistantly along such length.

The first locking mechanism 134 is adapted to be inserted into one of the longitudinally spaced holes 132 to fix the telescoping beam 130 to the ladder-jack housing 112 at the first desired effective length of the telescoping beam 130 (i.e., the length of the visible portion of the telescoping beam 130 that is extracted from the ladder-jack housing 112). In particular, the first locking mechanism 134 is a spring-button lock 134.

In particular and as shown in FIG. 8, a side of the telescoping beam 130 (corresponding to the side of the ladder-jack housing 112 defining the longitudinally spaced holes 132) defines an aperture 123 of the telescoping beam 130. The aperture 123 is located toward a rear end of the telescoping beam 130 (i.e., an end of the telescoping beam 130 located generally within the ladder-jack housing 112). A spring 127 of the spring-button lock 134 is disposed in the hollow interior of the telescoping beam 130. In a “relaxed” state of the spring-button lock 134, a push button 128 of the spring-button lock 134 extends from the spring 127, protrudes in and through the aperture 123, is disposed exterior the telescoping beam 130, and passes into one of the longitudinally spaced holes 132 of the ladder-jack housing 112 to, thereby, fix the telescoping beam 130 relative the ladder-jack housing 112 at a point represented by the longitudinally spaced hole 132. Sufficient depression of the push button 128 in a direction toward the ladder-jack housing 112 and telescoping beam 130 allows the telescoping beam 130 to slide continuously longitudinally in the hollow interior of the ladder-jack housing 112 such that the push button 128 can pass into another one of the longitudinally spaced holes 132. In this way, the first desired effective length of the telescoping beam 130 is satisfied.

The telescoping ladder jack 110 includes further at least a pair of ladder hooks 114, 116 attached to the respective first and second ends 115, 117 of the ladder-rung bracket 118 and hooked over corresponding rungs 129 of the ladder 111 to hook the ladder-rung bracket 118 and, thus, telescoping ladder jack 110 to the ladder 111. In particular, each of the ladder hooks 114, 116 is attached to a rear of the ladder-rung bracket 118 and extends across a substantial length of the rung 129.

The ladder-rung bracket 118 defines a substantially U-shaped transverse cross-section, and the first end 115 of the ladder-rung bracket 118 receives the ladder-jack housing 112 and the second end 117 of the ladder-rung bracket 118 receives the adjustable brace 120. The ladder-rung bracket 118 extends from one rung 129 to another rung 129 of the ladder 111.

The telescoping tube 113 defines an opposed first pair of orifices (not shown) of the telescoping tube 113, and the ladder-jack housing 112 defines an opposed second pair of orifices (not shown) of the ladder-jack housing 112 such that the first and second pairs of orifices are substantially aligned with respect to each other. A third locking mechanism 139 is disposed through the first and second pairs of orifices 135, 137 to mount the telescoping tube 113 to the ladder-jack housing 112. As so illustrated, the third locking mechanism 139 is a pin 139.

The ladder-jack housing 112 defines a telescoping-tube bracket 141 of the ladder-jack housing 112 to which the telescoping tube 113 is mounted. The telescoping-tube bracket 141 defines an inverted substantially U-shaped transverse cross-section and receives the telescoping tube 113. In particular, the telescoping-tube bracket 141 defines a bottom portion of the ladder-jack housing 112 and extends substantially an entirety of a length of a remainder of the ladder-jack housing 112.

Each of the telescoping tube 113 and adjustable brace 120 is substantially tubular and defines a substantially square transverse cross-section and hollow interior of the telescoping tube 113 and adjustable brace 120. A length of the telescoping tube 113 can be greater than, substantially equal to, or less than that of the adjustable brace 120, and an inner diameter defined by the telescoping tube 113 is only slightly greater than an outer diameter defined by the adjustable brace 120.

As illustrated in FIG. 7, the telescoping tube 113 defines a plurality of longitudinally spaced holes 131 of the telescoping tube 113. The longitudinally spaced holes 131 are defined on each of a pair of opposed sides of the telescoping tube 113 such that opposing ones of the longitudinally spaced holes 131 are substantially aligned with respect to each other. In particular, the longitudinally spaced holes 131 are defined on at least a substantial length of the corresponding side of the telescoping tube 113 and spaced substantially equidistantly along such length.

The adjustable brace 120 defines a plurality of longitudinally spaced holes 142 of the adjustable brace 120. The longitudinally spaced holes 142 are defined on each of a pair of opposed sides of the adjustable brace 120 such that opposing ones of the longitudinally spaced holes 142 are substantially aligned with respect to each other and the corresponding longitudinally spaced holes 131 of the telescoping tube 113. In particular, the longitudinally spaced holes 142 are defined on at least a substantial length of the corresponding side of the adjustable brace 120 and spaced substantially equidistantly along such length.

The second locking mechanism 119 is disposed through the longitudinally spaced holes 131, 142 of the telescoping tube 113 and adjustable brace 120 to fix the adjustable brace 120 at the second desired effective length and the ladder-jack housing 112 to a desired angle of incline with respect to the ladder-rung bracket 118. The second locking mechanism 119 is a pin 119. As the ladder-jack housing 112 is raised and lowered to the desired angle of incline of the ladder-jack housing 112 with respect to the ladder-rung bracket 118, the corresponding longitudinally spaced holes 131, 142 align with each other, and the pin 119 is inserted through a particular set of the aligned longitudinally spaced holes 131, 142. In this way, the second desired effective length of the adjustable brace 120 is satisfied, and, in turn, the ladder-jack housing 112 is locked in place at the desired angle of incline.

As illustrated in FIG. 1, the telescoping ladder jack 110 is adapted to support a scaffold plank/platform (not shown). To this end, the telescoping ladder jack 110 includes further a securing mechanism to secure the scaffold plank/platform to the telescoping beam 130 and ladder-jack housing 112. The securing mechanism includes a fixed lock 136 mounted to an end of the telescoping beam 130 located distal the ladder-jack housing 112 and an adjustable locking pin 138 that fits into the telescoping beam 130 by passing through a slot 140 defined in a top of the ladder-jack housing 112. The scaffold plank/platform is secured between the lock 136 and adjustable locking pin 138 to the telescoping beam 130 and ladder-jack housing 112. The slot 140 extends a substantial length of the ladder-jack housing 112, and a screw 137 is threaded through the lock 136 to the scaffold plank/platform.

In particular, the lock 136 is fixedly attached to the end of the telescoping beam 130 (through which the screw 137 is threaded). The locking pin 138 defines a substantially circular transverse cross-section and corresponding diameter of the locking pin 138 such that the locking pin 138 can be removably inserted into one of the longitudinally spaced holes 132 in the telescoping beam 130. The locking pin 138 also is a length of steel such that the locking pin 138 is longer than a depth of the ladder-jack housing 112. The locking pin 138 also may be removably placed into one of the longitudinally spaced holes 132 through the slot 140 in a top side of the ladder-jack housing 112. The slot 140 exposes a desired number of the longitudinally spaced holes 132 in any length of the telescoping beam 130 remaining retracted inside the ladder-jack housing 112. An operator of the telescoping ladder jack 110 (such as a roofer, sider, or painter) may set the telescoping beam 130 at, say, the first desired effective length and secure the scaffold plank/platform of varying widths to the telescoping beam 130 and ladder-jack housing 112 without his/her having to disassemble the telescoping ladder jack 110 for him/her to set the locking pin 138.

In operation of the telescoping ladder jack 110 and as illustrated in FIG. 6, the top and bottom ladder-rung hooks 114, 116 engage the respective rungs 129 of the ladder 111, thus securing the telescoping ladder jack 110 in place. The telescoping ladder jack 110 may then be adjusted by use of the telescoping tube 113 and adjustable brace 120. The telescoping beam 130 may then be set to the first desired effective length, and the scaffold plank/platform may be secured to the exposed telescoping beam 130 and ladder-jack housing 112 by employment of the lock 136 and locking pin 138.

It should be appreciated by those having ordinary skill in the related art that each of the ladder-jack housing 112, telescoping tube 113, ladder hooks 114, 116, ladder-rung bracket 118, second locking mechanism 119, adjustable brace 120, telescoping beam 130, first locking mechanism 134, lock 136, screw 137, locking pin 138, third locking mechanism 139, and telescoping-tube bracket 141 can have any suitable shape, size, and structure and structural relationship with each of the other structural elements of the telescoping ladder jack 110 and be made of any suitable material (such as one that meets safety-compliance standards). It should be so appreciated also that each of the longitudinally spaced holes 131, 132, 142, orifices, and slot 140 can have any suitable shape and size and structural relationship with a remainder of the telescoping ladder jack 110. It should be so appreciated also that the telescoping ladder jack 110 can define any suitable number of the longitudinally spaced holes 131, 132, 142, orifices, and slot 140 and include any suitable number of ladder hooks 114, 116 (which can engage any suitable respective rungs of the ladder 111). It should be so appreciated also that each of the first, second, and third locking mechanisms 134, 119, 139 and locking pin 138 can lock relative the corresponding longitudinally spaced holes 131, 132, 142, orifices, and slot 140 in any suitable manner. It should be so appreciated also that the ladder 111 can be any suitable type of ladder. It should be so appreciated also that the telescoping ladder jack 110 can be set to any suitable first and second desired effective lengths. It should be so appreciated also that the lock 136 can be mounted and locking pin 138 can be fixed to the telescoping beam 130 in any suitable manner and location.

The telescoping ladder jack 10, 110 is used on the inside of the ladder 11, 111. Also, the telescoping ladder jack 10, 110 does not limit range of the, say, roofer, sider, or painter. And, the telescoping ladder jack 10, 110 provides separation between the structure and ladder 11, 111 to facilitate work at higher elevation where pitch of the ladder 11, 111 narrows considerably. Furthermore, the telescoping ladder jack 10, 110 can be set at varying lengths from the roof or face of the structure. In addition, the telescoping ladder jack 10, 110 can securely lock the scaffold plank/platform of varying widths. Moreover, a work platform of the telescoping ladder jack 10, 110 is closer to the roof or face of the structure. Plus, the telescoping ladder jack 10, 110 can accommodate variations in angle of incline of the ladder 11, 111.

More specifically, the telescoping ladder jack 10, 110 employs a plurality of ladder-rung hooks 14, 16, 114, 116. Also, the telescoping ladder jack 10, 110 can adjust the ladder-rung hooks 14, 16, 114, 116 to varying degrees of incline. And, the ladder-rung hooks 14, 16, 114, 116 can be used to position the telescoping ladder jack 10, 110 on the inside of a ladder 11, 111. Furthermore, the telescoping ladder jack 10, 110 uses a telescoping beam 30, 130 that can be set at varying widths and locked in place. In addition, the telescoping ladder jack 10, 110 includes the locking pin 38, 138 that can be set at varying lengths and remain set when the telescoping beam 30, 130 is used. Moreover, the ladder-rung hooks 14, 16, 114, 116 can be removably attached and allow the telescoping ladder jack 10, 110 to be used on an outside of a new-construction wall as a support for a scaffold plank/platform when the ladder-rung hooks 14, 16, 114, 116 are removed and the top ladder-rung hook 14, 114 is replaced with a wider top-wall-plate hook. Plus, the telescoping ladder jack 110 includes two “telescoping” parts 130, 113 each of which is adapted to slide and be locked in a desired position such that the ladder-jack housing 112 of the telescoping ladder jack 110 can be raised and lowered to and locked in a desired angle.

The telescoping ladder jack 10, 110 has been described herein in an illustrative manner. It is to be understood that the terminology that has been used herein is intended to be in the nature of words of description rather than of limitation. Many modifications and variations of the assembly telescoping ladder jack 10, 110 are possible in light of the above teachings. Therefore, within the scope of the appended claims, the assembly telescoping ladder jack 10, 110 may be practiced other than as specifically described herein.

1. A telescoping ladder jack comprising:
a ladder-jack housing;
a telescoping beam adapted to be matingly inserted into and extracted from said ladder-jack housing such that a first desired effective length of said telescoping beam is extracted from said ladder-jack housing;
a first locking mechanism fixing said telescoping beam at said first desired effective length;
a ladder-rung bracket defining opposing first and second ends of said ladder-rung bracket and mounted to a ladder to mount said telescoping ladder jack to the ladder, said first end being pivotally attached to an end of said ladder-jack housing disposed distal said telescoping beam;
a telescoping tube mounted to said ladder-jack housing;
an adjustable brace adapted to be matingly inserted into and extracted from said telescoping tube such that a second desired effective length of said adjustable brace is extracted from said telescoping tube, an end of said adjustable brace disposed distal said telescoping tube being pivotally mounted to said second end of said ladder-rung bracket; and
a second locking mechanism adapted to fix said adjustable brace at said second desired effective length and said ladder-jack housing to a desired angle of incline with respect to said ladder-rung bracket.

2. A telescoping ladder jack as recited in claim 1, wherein said ladder-jack housing defines a plurality of longitudinally spaced holes of said ladder-jack housing.

3. A telescoping ladder jack as recited in claim 2, wherein said longitudinally spaced holes of said ladder-jack housing are defined on at least one side of said ladder-jack housing.

4. A telescoping ladder jack as recited in claim 2, wherein said first locking mechanism is adapted to be inserted into one of said longitudinally spaced holes to fix said telescoping beam at said first desired effective length.

5. A telescoping ladder jack as recited in claim 4, wherein said first locking mechanism is a spring-button lock.

6. A telescoping ladder jack as recited in claim 5, wherein said telescoping beam defines an aperture of said telescoping beam and a spring of said spring-button lock is disposed interior said telescoping beam and a push button of said spring-button lock extends from said spring, protrudes in and through said aperture, and is disposed exterior said telescoping beam.

7. A telescoping ladder jack as recited in claim 1, wherein said telescoping ladder jack comprises further at least a pair of ladder hooks attached to respective said first and second ends of said ladder-rung bracket and hooked over corresponding rungs of the ladder to hook said ladder-rung bracket and, thus, telescoping ladder jack to the ladder.

8. A telescoping ladder jack as recited in claim 1, wherein said ladder-rung bracket defines a substantially U-shaped transverse cross-section and said first end of said ladder-rung bracket receives said ladder-jack housing and said second end of said ladder-rung bracket receives said adjustable brace.

9. A telescoping ladder jack as recited in claim 1, wherein said telescoping tube defines a plurality of longitudinally spaced holes of said telescoping tube.

10. A telescoping ladder jack as recited in claim 9, wherein said longitudinally spaced holes of said telescoping tube are defined on each of a pair of opposed sides of said telescoping tube such that opposing ones of said longitudinally spaced holes are substantially aligned with respect to each other.

11. A telescoping ladder jack as recited in claim 1, wherein said telescoping tube defines an opposed first pair of orifices of said telescoping tube and said ladder-jack housing defines an opposed second pair of orifices of said ladder-jack housing such that said first and second pairs of orifices are substantially aligned with respect to each other and a third locking mechanism is disposed through said first and second pairs of orifices to mount said telescoping tube to said ladder-jack housing.

12. A telescoping ladder jack as recited in claim 11, wherein said third locking mechanism is a pin.

13. A telescoping ladder jack as recited in claim 11, wherein said ladder-jack housing defines a telescoping-tube bracket of said ladder-jack housing to which said telescoping tube is mounted.

14. A telescoping ladder jack as recited in claim 13, wherein said telescoping-tube bracket defines an inverted substantially U-shaped transverse cross-section and receives said telescoping tube.

15. A telescoping ladder jack as recited in claim 10, wherein said adjustable brace defines a plurality of longitudinally spaced holes of said adjustable brace.

16. A telescoping ladder jack as recited in claim 15, wherein said longitudinally spaced holes of said adjustable brace are defined on each of a pair of opposed sides of said adjustable brace such that opposing ones of said longitudinally spaced holes are substantially aligned with respect to each other and corresponding said longitudinally spaced holes of said telescoping tube and said second locking mechanism is disposed through said longitudinally spaced holes of said telescoping tube and adjustable brace to fix said adjustable brace at said second desired effective length and said ladder-jack housing to a desired angle of incline with respect to said ladder-rung bracket.

17. A telescoping ladder jack as recited in claim 16, wherein said second locking mechanism is a pin.

18. A telescoping ladder jack as recited in claim 1, wherein said telescoping ladder jack is adapted to support a scaffold plank and comprises further a securing mechanism to secure the scaffold plank to said telescoping beam and ladder-jack housing.

19. A telescoping ladder jack as recited in claim 18, wherein said securing mechanism includes a fixed lock mounted to an end of said telescoping beam located distal said ladder-jack housing and an adjustable locking pin that fits into said telescoping beam by passing through a slot defined in a top of said ladder-jack housing, the scaffold plank being secured between said lock and locking pin to said telescoping beam and ladder-jack housing.

20. A telescoping ladder jack as recited in claim 18, wherein said slot extends a substantial length of said ladder-jack housing and a screw is threaded through said lock to the scaffold plank.
